(19) United States
(12) Patent Application Publication
(10) Pub. No.: US 2009/0158494 A1
(43) Pub. Date: Jun. 25, 2009

(54) Pet carrier

(76) Inventor: Joseph E. McMullen, Greenville, SC (US)

Correspondence Address: Alan A. Csontos, 6 Triple Crown Court, Greenville, SC, 29615, US

(21) Appl. No.: 12/288,364

(22) Filed: Oct. 20, 2008

Related U.S. Application Data
(63) Continuation-in-part of application No. 12/004,699, filed on Dec. 21, 2007.

(51) Int. Cl. A41D 1/04; A41D 1/00; A41D 27/20; A01K 1/00

(52) U.S. Cl. 2/102; 2/69; 2/250; 119/497

(57) ABSTRACT

A garment for use as a pet carrier has a pouch located on the upper half of the garment. The pouch is formed between an inner layer and an outer layer which are attached to each other at or near each shoulder, at about mid-torso and at points on the side. The pouch has an opening at its top where means to open and close the pouch are located and which extend downward from the top. The garment has supports attached to the inner or outer layer near or at the shoulders, and which go over the shoulders and down the front or the back of the person to at least mid-torso, where the supports are attached to the inner or outer layer at the sides. The inner or outer layer and the supports can extend further downward to about the waist of the person

### REFERENCE TO RELATED APPLICATIONS

This application is a Continuation-in-Part of application Ser. No. 12/004,699 filed on Dec. 21, 2007.

### FIELD OF THE INVENTION

The present invention is in the field of apparel, and the invention relates to a garment worn by a person to carry small pets.

### BACKGROUND OF THE INVENTION

Many people have small pets such as cats, small dogs, rabbits, guinea pigs, ferrets, etc., which they would like to take with them on walks, bicycling, boating, and other activities. However, due to their size and other factors, small pets are difficult to be taken places or walked on a leash. Hence, various pet carriers have been devised to carry a small pet.

Even though this invention is a pet carrier, designs for baby carriers are noted. Hence, in this background, designs for both baby carriers and pet carriers are disclosed; it being understood that this invention is directed to pet carriers.

Three general types of devices are used as baby or pet carriers.

Harness Types. Many infant carrier designs feature a separate item of apparel which is worn over the shoulder and around the neck of the person with the infant secured in a harness with the baby's legs, arms and head protruding out. U.S. Pat. Nos. 4,434,920; 4,402,440; 5,791,535; 5,813,580; and 6,672,493 show the harness types. Other harness type carriers are for pets, and the design features a cage or garment attached to the harness. U.S. Pat. Nos. 5,044,321; 5,176,102; 5,277,148; and 6,701,871 and Design Pat. D370, 090; D334, 253 and D383, 305 show these harness types for pets.

Sling Types. Some patents show “sling” type carriers, in which a garment is worn over the shoulder(s) of the person and the baby placed in a holder which is worn on the side of the person. U.S. Pat. Nos. 4,166,558; 6,343,727; 6,435,185; and 6,595,396 show these sling types.

Coat Types. Some patents show a type of coat which covers the baby or pet while it is being carried. In U.S. Pat. No. 4,079,467, the baby is placed in a sling type carrier with a coat worn over the baby and person. The coat has a pocket for the baby's posterior to rest in. In U.S. Pat. No. 4,606,078, the baby is carried in a harness type apparatus, but a vest can be worn by the person against his/her body on the inside and a coat is worn on the outside of the person. The baby is in a carrier between the vest and the coat. U.S. Pat. No. 5,946,725 describes a garment worn by the person which allows the baby to be in contact with the skin of the person for comfort and nurture reasons (called Kangarooing). The garment has a pouch on its inside which holds the baby and covers it from the outside. Design Patent D539, 509 shows a garment where a pet is placed in a large front pocket, open at the top and located at the waist of the person.

### SUMMARY OF THE INVENTION

The pet carrier of the Invention is a garment having a pouch which, when worn by a person, is positioned on the upper torso in front or in back of the person. The pouch is formed between an inner layer which extends downward from about shoulder height to about mid-torso of the person, and an outer layer which extends downward from about shoulder height to about mid-torso of the person, at which mid-torso point the two layers are attached to each other. The inner layer and outer layer are also attached to each other at points at or near each shoulder. The inner and outer layers extend sideways to about the shoulders. The pouch has an opening at its top. Means are located at the opening at the top of the pouch on the outer layer to open and close the pouch, which means extend down the pouch. Hence, the pouch can be conveniently opened to place a pet into the pouch. The garment has supports attached to the top of the inner layer or outer layer, which supports extend over the shoulders and down to at least about mid-torso, where the supports are attached to the inner layer or outer layer.

The inner layer or outer layer of the garment, or both, or a separate piece attached to the inner layer or outer layer or both, can extend further downward in front, in back, or both front and back to about the waist of a person. The supports can extend downward to about the waist of the person. The inner layer or outer layer or separate piece and supports are attached at the sides.

The materials of construction of the garment and designs on the garment can be anything appropriate for use in a large variety of climate conditions or activities.

### BRIEF DESCRIPTION OF THE FIGURES

FIG. 1A shows the right-side front of a pet carrier garment having the appearance of a pull-over. A pouch is located in front on the upper torso of a person. The pouch is formed between an outer layer is a separate piece which is attached to an inner layer near the shoulders, at about mid-torso and at the sides. The pouch has an opening at the top with buttons on the outer layer which extend from the top of the pouch to about two-thirds down the pouch.

FIG. 1B shows the right-side back of a pet carrier garment having the appearance of a pull-over. Supports in back are attached to the outer layer in front and attached to the outer layer at the sides by tabs located at about the mid-torso of a person.

FIG. 2 shows the right-side front of a pet carrier garment which has the appearance of a poncho. The pouch is located in front on the upper torso of a person. Supports extend in back to about the waist where the support is attached by straps. The pouch has an opening at the top with snaps on the outer layer which extend down from the top to about half-way down the pouch. The pouch also has openings at both of its sides.

FIG. 3A shows the right-sided front of a pet carrier garment which has the appearance of a vest. The pouch is located in front on the upper torso of a person. Supports are attached to the outer layer of the pouch, and extend in back in a single piece to about the waist of a person. The outer layer has an opening near the top of the pouch where hooks and eyelets are located on the outer layer and extend from the top of the opening of the pouch to about half-way down the pouch. The pouch also has an opening near each of its sides.

FIG. 3B shows the right-sided front of a pet carrier garment which has the appearance of a vest. A pouch is located in front on the upper torso of a person. Supports are attached to the inner layer of the pouch, and extend in back in a single piece to about the waist of a person. The pouch has an opening at the top where interlocking hooks and pile are located on the outer layer and which extend from the top of the pouch to about three-quarters down the pouch.

FIG. 4 shows the right-sided front of a pet carrier garment which has the appearance of a vest. The pouch is located in front on the upper torso of a person. Supports are attached to the inner layer of the pouch, and extend in back in a single piece to about the waist of a person. The pouch has an opening at the top where a zipper is located on the outer layer of the pouch which extends from the top of the pouch to about half-way down the pouch. The outer layer also has openings on the sides of the pouch and pockets near the waist of a person.

FIG. 5A shows the right-sided front of a pet carrier garment which has the appearance of a sweater. The pouch is located in front on the upper torso of a person. Supports, which are attached to the inner layer of the pouch, have a sleeve attached at each shoulder which sleeve extends down the arm of a person to about the wrists. The pouch has an opening at the top where a cord is located on the outer layer of the pouch which extends from the top of the pouch to about sixty percent of the way down the pouch. The outer layer also has openings on the sides of the pouch.

FIG. 5B shows the right-sided back of a pet carrier garment which has the appearance of a sweater. The pouch is located in back on the upper torso of the person. Supports, which are attached to the inner layer of the pouch, have a sleeve attached at each shoulder which sleeve extends down the arm of a person to about the wrists. The pouch has an opening at the top where a zipper is located on the outer layer of the pouch which extends from the top of the pouch to about one-half way down the pouch.

FIG. 6 shows a view of a person wearing a sweater-type pet carrier garment with a small dog in the pouch. The pouch is located in front on the upper torso of a person. The pouch has an opening near the top where a zipper is located on the outer layer of the pouch which extends from the top of the opening to about two-thirds of the way down the pouch. The outer layer has openings on the sides of the pouch and pockets near the sides near the waist of a person.

### DETAILED DESCRIPTION OF THE INVENTION

The invention is a garment which is worn by a person to carry a small pet. The garment has a pouch which is located at the upper torso between the shoulders and from the shoulders to about the mid-torso of the person and which is formed between an inner layer and an outer layer. In this location, the pouch provides greater safety and security for the pet because the pet is less prone to being bumped by the person wearing the garment or by another person or object. Further, the close proximity of the pet in the pouch to the heart of the person provides comfort and intimacy to the pet which can hear or feel the heartbeat of the person. The top of the pouch has an opening at its top so the pet can stick out its head and see the person and other things.

The garment can be worn with or without the pet placed inside of the pouch, and yet maintain the appearance of a traditional article of apparel. This feature enhances the utility of the garment because it does not require the person wearing the garment to carry additional apparel and/or change apparel to carry the pet and for different social settings.

With the pouch in front, the supports are attached to the inner layer or outer layer or both at or near the shoulders, and go over the shoulders and down the back of the person to at least the mid-torso where the supports are attached to the inner layer or outer layer at or near the sides.

Although the garment is normally worn so that the pouch is in front, the garment can be made with the pouch located on the upper torso in the back. With the pouch in back, the supports are attached to the inner layer or outer layer or both at or near the shoulders, and go over the shoulders, around the neck and continue down the front in a single piece to at least the mid-torso of the person where the supports are attached to the inner layer or outer layer at or near the sides. With the pouch worn on the back, the person's arms and hands are freer to use.

At the opening at the top of the pouch, means are located to open and close the pouch. The means extend downward from the top of opening of the pouch to at least about one-quarter of the way down the pouch, and can extend downward to substantially the bottom of the pouch. More preferred, the means extend from the top of the opening to about two-thirds of the way down the pouch. The means permit the pouch to be opened to allow for a pet to be easily placed into the pouch. The means can then be used to close, or at least partially close, the pouch to secure the pet in the pouch. The means employed are zippers, hooks, hooks and eyelets, fasteners, snaps, buckles, buttons, cords, strings, twine, interlocking hooks and pile (sold under the trademark Velcro) and the like.

The garment, in all of its embodiments and design variations, can also have an opening at one or both sides of its pouch. An opening at the side of the pouch can also be used to place the pet into the pouch. The openings at the sides of the pouch can be closed once the pet is placed inside. Hence, the side openings of the pouch can have means such as a zipper, hooks, hooks and eyelets, fasteners, snaps, buckles, buttons, cords, strings, twine, interlocking hooks and pile (which is sold under the trademark Velcro0 and the like, which means can be used to close the side openings. The garment can also have pockets at its sides near the waist.

In the invention, the phrase “attached” means that the inner layer or outer layer or both are normally secured to each other and to the supports by virtue of how the layers and supports are manufactured, such as being a continuous piece woven together, or by sewing or stitching the layers and supports together. However, the layers and supports can also be “attached” to each other by means such as zippers, hooks, hooks and eyelets, fasteners, snaps, buckles, buttons, cords, strings, twine, interlocking hooks and pile (which is sold under the trademark Velcro) and the like. Typically, the inner layer or outer layer or both are attached to each other and to the supports by sewing or stitching the layers and supports together at positions and locations on the garment where seams normally occur. This helps in the construction of the garment and enhances the look of the garment.

In one embodiment of the invention, the garment has the appearance of a pull-over, and the garment basically comprises the inner layer, the outer layer and the supports. The pouch is located at a position which, when the garment is worn by a person, is between the shoulders and the shoulders and the mid-torso of the person. The pouch is formed between an inner layer which extends from near or at the shoulders of the person downward to about the mid-torso of the person, and an outer layer which also extends from near or at the shoulders to about the mid-torso of the person. The inner layer and outer layer are attached to each other at or near the shoulders, at about mid-torso and at the sides. The pouch has an opening at the top. Means to open and close the pouch are located on the outer layer of the pouch. The garment has supports which attach to the inner layer or outer layer or both, and which extend over the shoulders and downward, where the supports are attached to the inner layer or the outer layer or both layers at the sides.

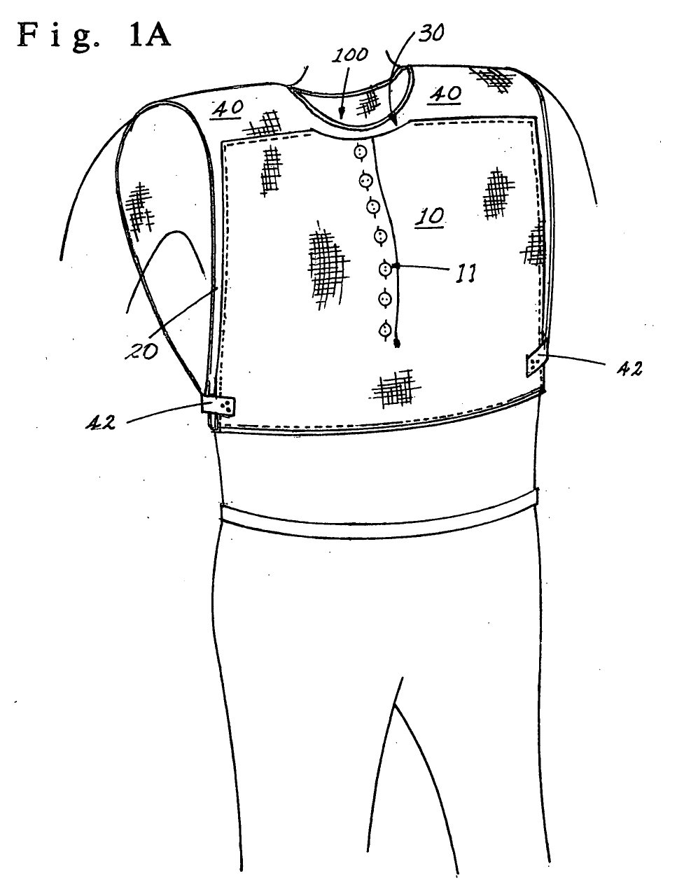

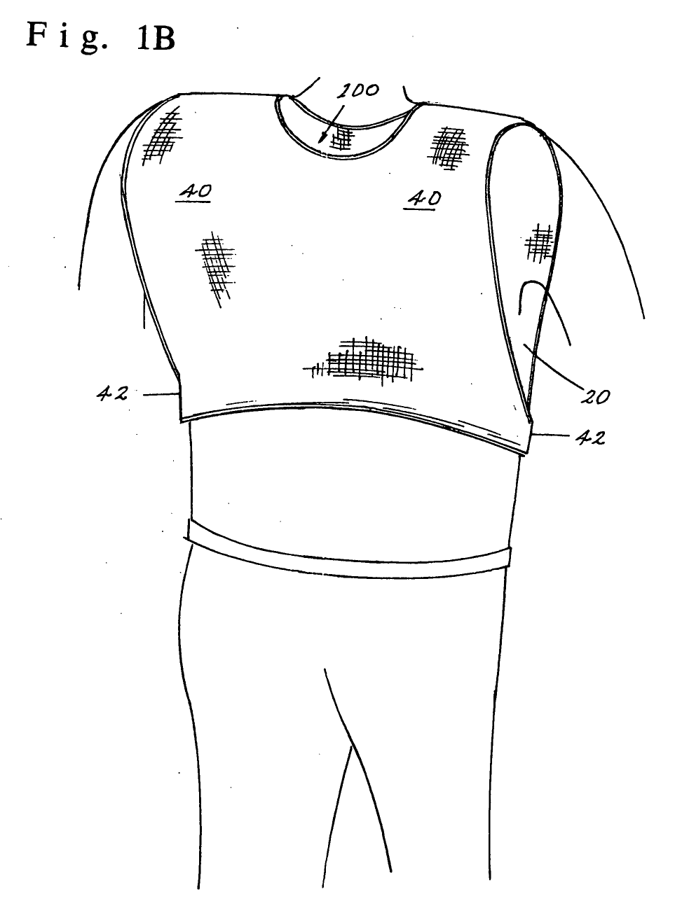

FIG. 1A depicts the right-sided frontal view of a pet carrier garment which has the appearance of a pullover. The pouch is located in front at a position which, when worn by a person, is between the shoulders and from near the shoulders to about the mid-torso of the person. The pouch is formed between an outer layer (10) which is a separate piece attached to an inner layer (20) near each shoulder, at about mid-torso and at the sides. Supports (40) are attached to the inner layer and extend over the shoulders and down the back of the person. The pouch has an opening (30) at its top near its middle. The pouch has buttons (11) located at the top of the opening of the pouch which extend about two-thirds of the way down the pouch. The garment has an opening for the head (100) of the person. The supports (40) are attached to the outer layer at the sides by buckles (42).

In the embodiment described above, the supports can be attached to the inner layer or outer layer in various ways. FIG. 1B shows the right-sided back of a pet carrier garment similar to that depicted in FIG. 1A. In FIG. 1B, the supports (40) are attached to the inner layer (20) near the shoulders, and the supports extend over the shoulders, around the neck and down the back of the person in a single piece to about mid-torso. The supports are attached to the outer layer at the sides near the mid-torso of the person by means such as buckles (42), but these can be snaps, interlocking hooks and pile and the like.

In FIGS. 1A and 1B shown above, the supports are attached to the inner layer as a continuously woven material. However, the supports are typically attached to the inner or outer layer by sowing or stitching at or near the shoulders. Other means can be used to attach the supports to the inner layer or the outer layer. Whether the pouch is in front or in back, the supports essentially cover the shoulders of the person wearing the garment because this provides the most comfort to the person.

In another embodiment of the invention, the garment has the appearance of a poncho. The garment has a pouch located at a position which, when the garment is worn by a person, is on the upper torso between the shoulders and from the shoulders and about to the mid-torso of the person. In this embodiment, the inner layer or outer layer extends further downward to about the waist of a person. The supports of the garment attach to the inner layer or outer layer near or at the shoulders, and go over the shoulders, around the neck and down in a single piece to about the waist of the person, where the supports and the inner layer or outer layer are attached at the sides.

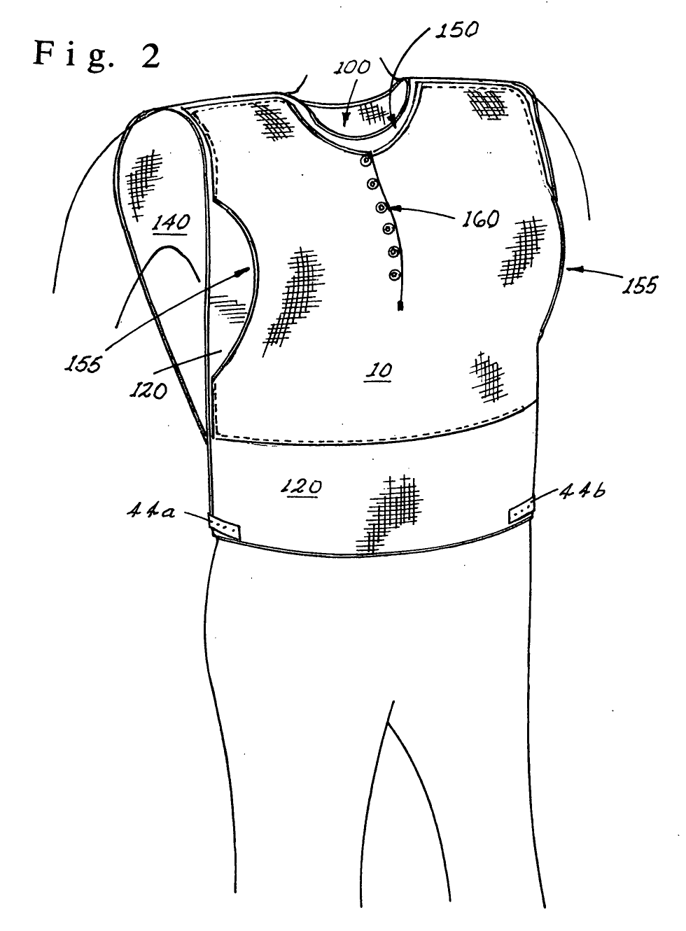

FIG. 2 shows the right-side front of a garment which has the appearance of a poncho. The pouch is located in front at a position which, when the garment is worn by a person, is between the shoulders and from the shoulders to about the mid-torso of the person. The pouch is formed between an inner layer (120) which is attached to an outer layer (10) at each shoulder, at about mid-torso and at points at the sides. The inner layer (120) extends downward in front to about the waist of the person. The supports (140) are attached to the inner layer at the shoulders, and extend over the shoulders, around the neck and down the back of the person in a single piece to about the waist of the person. The inner layer and the supports are attached at the sides near the waist by straps (44a and 44b). The pouch has an opening (150) at the top, and also has openings (155) on both sides. The pouch has snaps (160) located at the top of the opening of the pouch, which extend downward to about half-way down the pouch. The garment has an opening for the head (100)

In yet another embodiment of the invention, the garment has the appearance of a vest. The garment has a pouch which is located on the upper torso, and which is formed between an outer layer and an inner layer where one of the layers is a piece of material separate from but attached to the other layer. When the inner layer is a separate piece, it is attached to the outer layer at points which, when the garment is worn by a person, near or at the shoulders, at about mid-torso and on the sides. The outer layer extends downwards in front to about the waist of a person. The supports are attached to the outer layer near or at the shoulders, and go over the shoulders, around the neck and down the back in a single piece to about the waist of the person. The outer layer and the supports are attached at the sides. The outer layer in front has an opening at the top of the pouch, and can have an opening at one or both sides of the pouch.

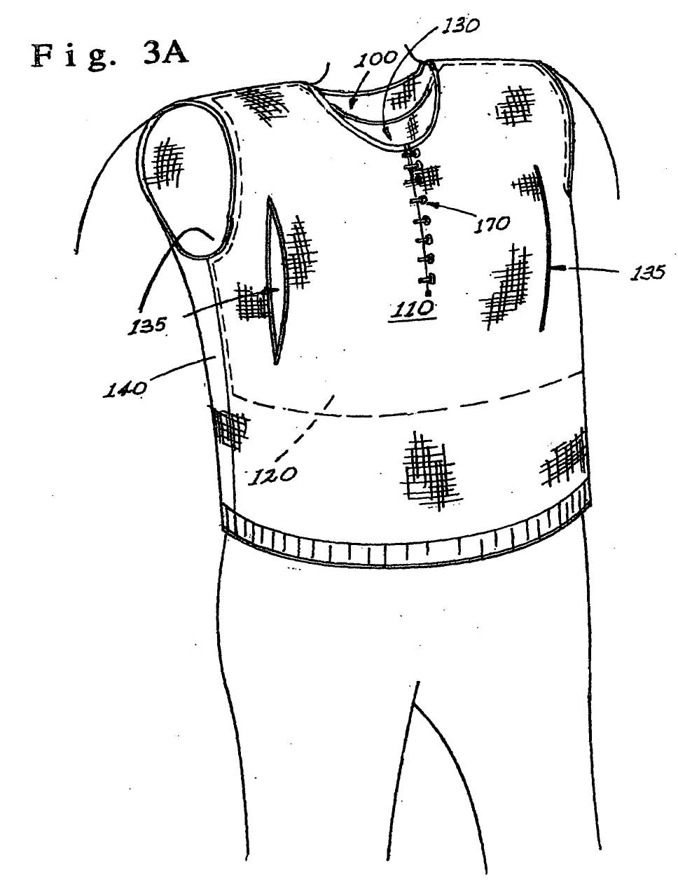

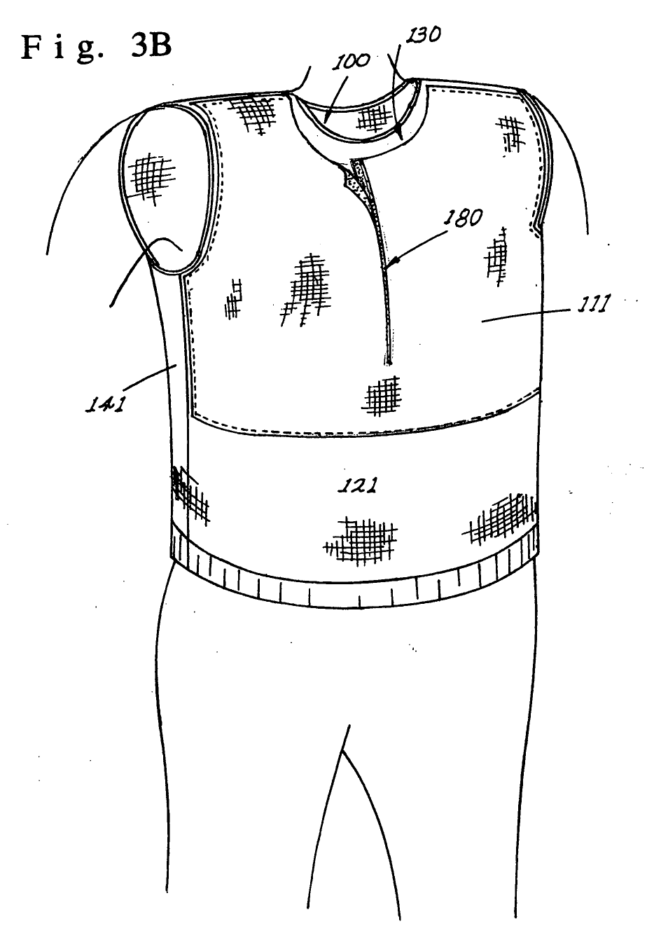

FIG. 3A shows a vest type garment pet carrier. The pouch is located in front on the upper torso, and is formed between an outer layer (110) and an inner layer (120) which is a separate piece, where the inner layer is attached to the outer layer at the shoulders, at about mid-torso and at the sides. The outer layer (110) extends downward in front to about the waist of the person. The supports (140) are attached to the outer layer at the shoulders, and go over the shoulders, around the neck and down the back of the person in a single piece to about the waist of the person. The outer layer and supports are attached at the sides. The outer layer has an opening (130) near the top of the pouch, and has openings (135) near the sides of the pouch. The pouch has hooks and eyelets (170) located at the top of the opening of the pouch on the outer layer, which extend from the top of the opening to about half-way down the pouch.

In another variation of the vest type pet carrier, the pouch is formed between an inner layer and an outer layer which is a separate piece attached to the inner layer at points near or at each shoulder, at about mid-torso and at the sides. The inner layer extends in front from about the shoulders to about the waist of the person. The garment has supports which are attached to the inner layer and go over the shoulders, around the neck and down the back of the person in a single piece. The top of the pouch has an opening near its middle and has means to open and close the pouch. The inner layer is attached to the supports at the sides. The front of the outer layer can also have openings at one or both sides of the pouch, and the inner layer can have pockets on the sides at about the waist of a person.

FIG. 3B shows the right-sided front of a vest-type pet carrier. The pouch is located in front on the upper torso, and is formed between an inner layer (121) and an outer layer (111) which is a separate piece attached to the inner layer at positions which, when the garment is worn by a person, are at the shoulders, at about mid-torso and the sides. The inner layer (121) extends downward in front from about the shoulders to about the waist of a person. The supports (141) are attached to the inner layer at the shoulders, and go over the shoulder, around the neck and down the back of the person in a single piece to about the waist of the person. The inner layer and supports are attached at the sides. The pouch has an opening (130) at the top near its middle. The pouch has interlocking hooks and pile (180) (sold under the trademark Velcro) located at the top of the opening of the pouch, which extend from the top of the opening to about three-quarters of the way down the pouch.

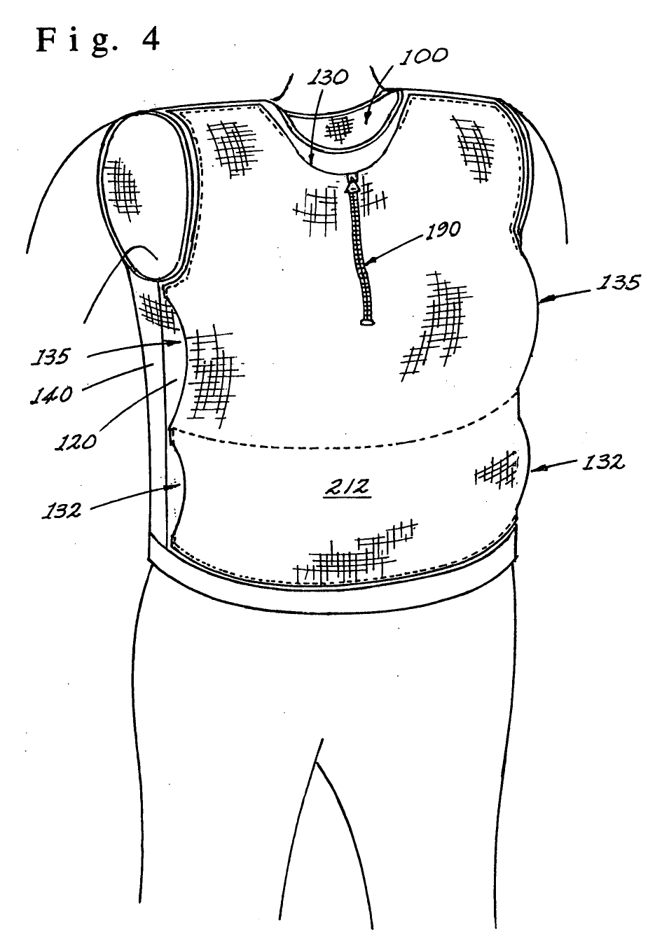

FIG. 4 shows yet another variation of the vest type pet carrier garment. The pouch is formed in front between an outer layer (212) and an inner layer (120) both of which have a similar shape and size. This variation can enhance the look and appeal of the garment. The inner layer and the outer layer both extend downward from the shoulders to about the waist of a person. In FIG. 4, the outer layer (212) is a separate piece attached to the inner layer (120) at the top of the shoulders, at about mid-torso, at about the waist and at points on the sides. The pouch has an opening (130) at the top, and openings (135) on both of its sides. The pouch has a zipper (190) located at the top of the opening of the pouch, which extends from the top of the opening to about two-thirds of the way down the pouch. The supports (140) are attached to the inner layer at the shoulders, and go over the shoulders, around the neck and down the back of the person in a single piece. The inner layer and supports are attached at the sides. The outer layer in front has a section below the pouch which has pockets (132) near the waist of a person.

In the above embodiments and variations, instead of the inner layer or the outer layer or both extending downward from where they are attached at about the mid-torso to about the waist of the person, a separate piece of material can be attached to the inner layer or outer layer or both at about the mid-torso and this separate piece can extend down to about the waist.

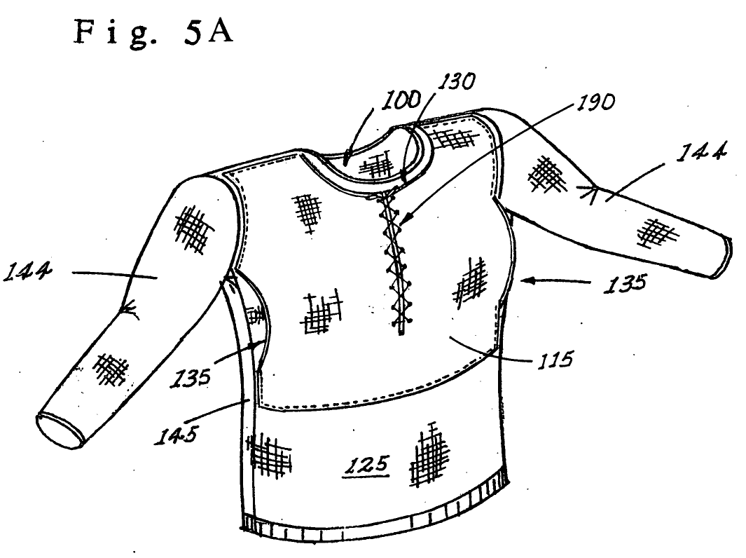

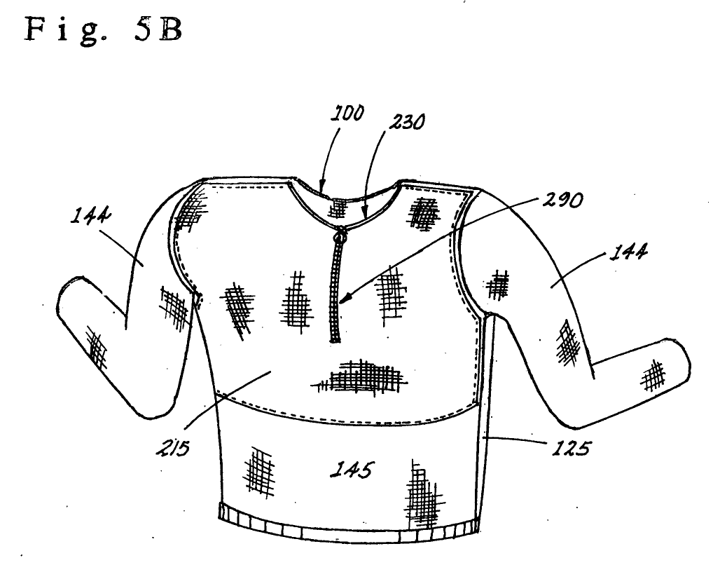

In yet another embodiment of the invention, the garment has the appearance of a sweater which has sleeves attached to the supports, and which extend down the arms to at least the elbows and typically to the wrists of a person. FIG. 5A illustrates this embodiment. In FIG. 5A, the outer layer (115) is a separate piece attached to the inner layer (125) at points which, when the garment is worn by a person, are at each shoulder, at about mid-torso and at points on the sides. The supports (145) are attached to the inner layer at the shoulders, and go over the shoulders, around the neck and down the back in a single piece to about the waist of the person. The inner layer (125) extends down to about the waist of a person. The inner layer and supports are attached at the sides. The sleeves (144) are attached to the supports at the shoulders. The pouch has an opening (130) at the top, and openings (135) at both of its sides. The pouch has a cord (190) located at the top of the opening of the pouch, which extends from the top of the opening to about sixty percent of the way down the pouch.

As with the other embodiments, the sweater-type pet carrier garment can be worn with the pouch in back. In this case, the supports are attached to the inner layer or the outer layer near or at the shoulders, and go over the shoulders, around the neck and extend downward in front in a single piece to about the waist of the person, where the supports are attached to the inner layer or outer layer at the sides. If the pouch is worn in back, there is normally no need for openings in the side of the pouch or for pockets.

FIG. 5B illustrates the variation where the pouch is in back. In FIG. 5B, the outer layer (215) is a separate piece attached to the inner layer (145) at points which, when the garment is worn by a person, are at each shoulder, at about mid-torso and at the sides. The supports (125) are attached to the inner layer at the shoulders, and go over the shoulders, around the neck and down the front in a single piece to about the waist of the person. The inner layer (145) extends down to about the waist of a person. The inner layer and supports are attached at the sides. The sleeves (144) are attached to the supports at the shoulders. The pouch has an opening (130) at the top. The pouch has a zipper (290) located at the top of the opening of the pouch, which extends from the top of the opening to about one-half of the way down the pouch.

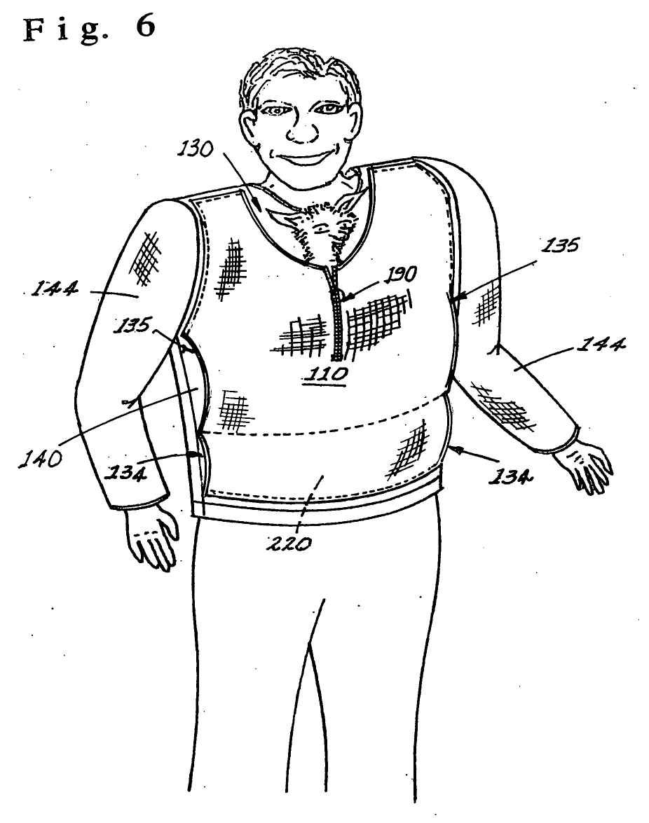

FIG. 6 shows a view of a person wearing a sweater-type pet carrier garment with the pouch in front on the upper torso and a small dog in the pouch. The garment has an outer layer (110) which is a separate piece of material which extends downward in front from at the shoulders to about the waist of the person. The inner layer (220) is attached to the outer layer (110) at the shoulders, at about mid-torso, at about the waist and at points at the sides. The supports (140) are attached to the inner layer (220) at the shoulders, and go over the shoulders, around the neck and down the back in a single piece to about the waist of the person. The inner layer and the supports are attached at the sides. The outer layer (110) has an opening (130) near the top of the pouch, and has openings (135) at the sides of the pouch. The pouch has a zipper (190) located at the top of the opening of the pouch, which extends from the top of the opening to about half-way down the pouch. The outer layer (220) has a section below the pouch which has pockets (134) at each side near the waist so the person can place his/her hands or other objects inside.

The materials of construction used for the layers and the supports, and other items of the garment can be any appropriate material. Typically, the materials are the same materials used to make garments worn by persons or pets. The materials can be natural materials such as cotton, wool, leather and the like, or synthetic materials such as nylon, polyester, Kevlar and the like, or the materials can be made out of mixtures of natural and synthetic materials. In a given pet carrier, the materials for the layers, the supports, and other items can be the same or different. The materials can be made into fabrics which can be reinforced, especially in the area of the pouch. The fabrics can be chosen to make a pet carrier for light summer wear, or for heavier winter wear, or for use in any season. For comfort, the inner layer of the pouch can be made of a softer, more breathable fabric or weave, and the outer layer of the pouch can be made of a fabric having good water or dirt repellency. The pouch can have a liner on the inside of the pouch which is made of a material that protects against the claws of the pet, and can have a liner made of a material that permits easier cleaning of the garment in case of accidents.

The pet carrier can have any kind of design on it. Pet owners often like to personalize items for their pets. Hence, designs can range from favorite colors and patterns, to pictures of types of pet, to scenes, to photographs of the pets and the like.

The embodiments, Figures and variations described herein are illustrative of the invention, and are not intended to limit the designs of the pet carrier garment.

I claim:

1. A garment for use as a pet carrier having a pouch located on the upper torso when the garment is worn by a person, said pouch formed between an inner layer which extends downward from near or at the shoulders to at least about the mid-torso of the person and an outer layer which extends downward from near or at the shoulders to at least about the mid-torso of the person, where the inner layer and outer layer are attached to each other near or at the shoulders, at about mid-torso, and at points at the sides; wherein the top of the pouch has an opening at its top and the pouch has means to open and close the pouch located at the top of the opening of the pouch which means extend downward from the top of the opening of the pouch; and said garment having supports attached to either one of the inner layer or outer layer near or at the shoulders, which supports go over the shoulders, around the neck and downward to about mid-torso, where the supports are attached to either one of the inner layer or outer layer.

2. A garment of claim 1, wherein the pouch has an inner layer which extends downward in front to about the mid-torso of the person and an outer layer which is a separate piece which extends downward in front to about mid-torso, where the outer layer is attached to the inner layer at the shoulders, at about the mid-torso and at the sides; and wherein the supports go over the shoulder, around the neck and extend downwards in back in a single piece to about the waist where the supports are attached to the inner layer or the outer layer at the sides.

3. A garment of claim 1, wherein the pouch has an outer layer which is a separate piece which extends downward in front from near the shoulders to about the mid-torso of the person and an inner layer which extends downward in front from near the shoulders to about the waist, where the inner layer is attached to the outer layer near the shoulders, at about the mid-torso and at the sides; and wherein the supports go over the shoulder, around the neck and extend downwards in back in a single piece to about the waist where the supports are attached to the inner layer at the sides.

4. A garment of claim 1, wherein the pouch has an inner layer which extends downward in front from near the shoulders to about the waist of the person and an outer layer which is a separate piece which extends downward in front from at the shoulders to about the mid-torso, where the outer layer is attached to the inner layer at the shoulders, at about the mid-torso and at the sides; and wherein the supports go over the shoulder, around the neck and extend downwards in back in a single piece to about the waist where the supports are attached to the outer layer at the sides.

5. A garment of claim 1, wherein the pouch has an outer layer which is a separate piece which extends downward in front from at the shoulders to about mid-torso of the person and an inner layer which extends downward in front from at the shoulders to about the waist, where the outer layer is attached to the inner layer at the shoulders, at about mid-torso and at the sides; and wherein the supports go over the shoulders, around the neck and extend downwards in back in a single piece to about the waist where the supports are attached to the inner layer at the sides.

6. A garment of claim 1, wherein the pouch has an outer layer which extends downward in front from at the shoulders to about the waist of the person and an inner layer which is a separate piece which extends downward in front from at the shoulders to about mid-torso, where the outer layer is attached to the inner layer at the shoulders, at about mid-torso and at points at the sides; and wherein the supports go over the shoulders, around the neck and extend downwards in back in a single piece to about the waist where the supports are attached to the outer layer at the sides.

7. A garment of claim 1, wherein the pouch is located in front on the upper torso, and the pouch has an outer layer which is a separate piece which extends downward in front from at the shoulders to about the waist of the person and an inner layer which extends downward in front from near the shoulders to about the waist, where the inner layer is attached to the outer layer at the shoulders, at about mid-torso, at the waist and at points at the sides; and wherein the supports go over the shoulders, around the neck and extend downwards in back in a single piece to about the waist where the supports are attached to the inner layer at the sides, and pockets are located at the waist.

8. A garment of claim 1, wherein the pouch is located in front on the upper torso, and the pouch has an inner layer extending downward in front to about the waist of the person and an outer layer which is a separate piece extending downward in front to about the mid-torso, where the inner layer and outer layer are attached to each other at each shoulder, at about the mid-torso and at point on the sides; and wherein the supports go over the shoulder, around the neck and extend downwards in back in a single piece to about the waist of the person; and the supports are attached to the inner layer at the sides and the supports have sleeves attached which extend down each arm to at least the elbows.

9. A garment of claim 1, wherein the pouch is located in back on the upper torso, and the pouch has an inner layer extending downward in back to about the waist of the person and an outer layer which is a separate piece which extends downward in back to about the mid-torso, where the inner layer and outer layer are attached to each other at each shoulder, at about the mid-torso of the person and at the sides; and wherein the supports go over the shoulder, around the neck and extend downwards in front in a single piece to about the waist of the person; and the supports are attached to the inner layer at the sides and the supports have sleeves attached which extend down each arm to at least the elbows.

10. A garment of claim 1, wherein the means used to open and close the pouch are selected from the group consisting of zippers, hooks, hooks and eyelets, fasteners, snaps, buckles, buttons, cords, strings, and interlocking hooks and pile.

11. A garment of claim 8, wherein the outer layer in front has pockets at each side near the waist of the person.

12. A poncho suitable for holding a small pet in a pouch which is located on the upper half of the poncho, said pouch formed between an inner layer and an outer layer which are attached to each other near or at the top of the poncho, at about mid-torso and at points on the sides, where the inner layer and the outer layer extend sideways to each side of the poncho; and wherein the pouch has an opening at its top and the pouch has means to open and close the pouch located at the top of the pouch and extending downward from the top of the pouch.

13. A vest suitable for holding a small pet in a pouch which is located on the upper half of the vest, said pouch formed between an inner layer and an outer layer which are attached to each other at the top of the vest, at about mid-torso and at the sides, where the inner layer and the outer layer extend sideways to each side of the vest; and wherein the pouch has an opening at its top and the pouch has means to open and close the pouch located at the top of the pouch and extending downward from the top of the pouch.

14. A sweater suitable for holding a small pet in a pouch which is located on the upper half of the sweater, said pouch formed between an inner layer and an outer layer which are attached to each other at each shoulder, at about mid-torso and at the sides, where the inner layer and the outer layer extend sideways to each side of the sweater; and wherein the pouch has an opening at its top and the pouch has means to open and close the pouch located at the top of the pouch and extending downward from the top of the pouch.

15. A sweater suitable for holding a small pet in a pouch which is located on the upper half of the sweater, said pouch formed between an inner layer and an outer layer which are attached to each other at each shoulder, at about mid-torso, at the waist and at the sides, where the inner layer and the outer layer extend sideways to each side of the sweater; and wherein the pouch has an opening at its top and the pouch has means to open and close the pouch located at the top of the pouch and extending downward from the top of the pouch and the outer layer has pockets near the waist.
